(19) United States
(12) Patent Application Publication
(10) Pub. No.: US 2016/0189246 A1
(43) Pub. Date: Jun. 30, 2016

(54) SYSTEMS AND METHODS FOR DEVELOPMENT OF AUDIENCE-CENTRIC MESSAGING TEMPLATES AND MESSAGE CONTENT FOR USE IN BUSINESS-TO-BUSINESS SALES AND MARKETING

(71) Applicant: SiriusDecisions, Inc., Wilton, CT (US)

(72) Inventors: Richard Eldh, Westport, CT (US); Anthony Jaros, Brookfield, CT (US); John Neeson, Ridgefield, CT (US); Erin Provey, Fairfield, CT (US); Marisa Kopec, Stamford, CT (US)

(21) Appl. No.: 14/855,445

(22) Filed: Sep. 16, 2015

Related U.S. Application Data
(60) Provisional application No. 62/051,420, filed on Sep. 17, 2014.

(51) Int. Cl. G06Q 30/02

(52) U.S. Cl. CPC G06Q 30/0276; G06Q 30/0269

(57) ABSTRACT

The present invention provides a repeatable, sequential approach for portfolio marketers to originate messaging that is highly relevant to buyers by replacing internally focused perspectives and vernacular with topics, language and value propositions that reflect market trends and buyer needs. A sequence of eight automated or semi-automated processes brings order and precision to the creative process of b-to-b messaging. Like the chambers of a nautilus shell, the progression of activities provided by the present invention is arranged in an expanding sequence of arcs, each of which represents a step in the messaging process.

This application claims the benefit of U.S. Provisional Application No. 62/051,420 filed on Sep. 17, 2014 which is incorporated herein and made a part hereof by reference for all purposes.

### BACKGROUND OF THE INVENTION

The present invention relates to the field of sales and marketing. More specifically, the present invention relates to systems and methods for a sequential approach to creating business-to-business (b-to-b) marketing messages.

Research shows that messaging origination is often characterized by misalignment, process breakdowns and skills gaps, causing the production of ineffective content. At the heart of this problem are flawed and obsolete messaging templates that center around either an offering, an aspirational product category, or a brand identity. Accordingly, it is submitted that portfolio marketers (product, solution, industry or segment) must reinvent their messaging templates and content creation processes to stay relevant in today's business environment.

The logical progression of a Fibonacci sequence can advantageously be applied to the creative process of planning and producing b-to-b messaging. In a Fibonacci sequence, named for 12th-century Italian mathematician Leonardo Fibonacci, pairs of numbers are successively added (e.g. 1+1=2, 1+2=3, 2+3=5, 5+3=8) to create a distinctive pattern of progression. Many expansive patterns in nature (e.g., tree leaves, hurricanes, nautilus shells) embody Fibonacci sequences.

It would be advantageous to provide a messaging methodology shaped like a nautilus shell, which starts with the audience—not the offering—at its center. It would be further advantageous to provide a repeatable, sequential approach for portfolio marketers to originate messaging that is highly relevant to buyers by replacing internally focused perspectives and vernacular with topics, language and value propositions that reflect market trends and buyer needs.

The systems and methods of the present invention provide the foregoing and other advantages.

### SUMMARY OF THE INVENTION

Automated methods and systems are provided for creating marketing messaging templates and messaging content. In an example embodiment, a sequence of automated messaging processes are provided.

An audience isolation sequence is provided for defining a target audience for the message and categorizing associated content, the target audience being defined by personas entered into a database in a prioritized manner and associated with content stored in the database. Market segmentation and sizing data is either input into the database or the user can leverage data provided in a corresponding tool to select which market segments to focus the content and campaigns on. The market segmentation levels include industry, sub-vertical, enterprise size and geographic regions.

Once the market segments are chosen, there is an automated method for calculating buyer audiences (buying centers and buyer personas) to target with the messaging. There is a scoring mechanism based on a series of attributes (which, e.g., may be obtained from the SiriusDecisions Persona Prioritization framework) that enables the user to select which persona targets are recommended by the tool as the best candidates.

A persona context sequence is provided for identifying buyer need and buyer-specific lexicon for each of the personas, and storing persona attributes in the database for each of the personas. This tool leverages the SiriusDecisions Buyer Persona Framework, which is a definitional model representing a series of required attributes to categorize and define a b-to-b buyer persona. The user can either input their own data into the tool or leverage pre-existing data that the tool provides based on research undertaken by SiriusDecisions.

An intent sequence is provided for defining and documenting message intent of the message for each of three demand types comprising new concept, new paradigm, and established markets, and assigning a demand type and strategy statement to each offering, the demand types and strategy statements being entered into the database.

A value proposition sequence is provided for creating definitions for one or more value propositions for an offering subject to the message and the corresponding demand type, and storing the definitions in the database. The value proposition framework is devised of five critical information components: persona, need, assertion, outcome and distinction. The system provides a worksheet and templates for the user to construct the components of the value proposition and then to assemble those components together into one or more value propositions.

An inflection points sequence is provided for defining buyer information needs and content preferences for the message, and storing the inflection points in the database. The system prompts the user with the types of questions a buyer persona will ask at each phase of the SiriusDecisions Buying Decision Framework. This framework embodies the human cognitive process of purchasing decision making for b-to-b offerings.

A narrative elements sequence is provided for creating core messaging components for the message for each demand type and storing the messaging components in the database. The system provides a set of worksheets and templates for the user to use in constructing the narrative elements aligned to the various phases of the buying decision process.

An activation mapping sequence is provided for constructing a content blueprint for assembling one or more of the messaging components to create messaging templates, which are stored in the database. The system provides a worksheet and templates for constructing the content blueprint. The database provides the users with the interaction types and content assets types most used by the buyer persona as well as those deemed most impactful to the decision phase based on SiriusDecisions research. In addition, the user has the ability to enter in their own custom market research to build the content blueprint.

An operationalize sequence is provided for automatically populating the messaging templates based on the messaging components. The operationalize sequence provides the completed messaging template, an aggregation of all previous sequences, to support internal workflow for campaign execution and content activation, such as audit trails, approval rights and delivery mechanisms.

The populated messaging templates may then be activated for electronic delivery to the content distribution channels such as an internal sales portal or external website, social media property or marketing automation tool. The APIs to those systems are standard interfaces.

The tools of the present invention also encompass basic user and administrator reporting features and functions.

### BRIEF DESCRIPTION OF THE DRAWINGS

The present invention will hereinafter be described in conjunction with the appended drawing figures, wherein like reference numerals denote like elements, and:

FIG. 1 shows an example illustration of the methodology of the present invention in the form of eight arcs progressing in the form of a nautilus, in accordance with an example embodiment of the invention;

FIG. 2 shows an example embodiment of an output of the Audience Framework process of Arc 1; and

FIG. 3 is a high-level block diagram of an example embodiment of a system for implementing the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

The present invention provides a methodology for creating messaging that connects with buyer and customer audiences using a logical progression of messaging activities. The methodology may be computer implemented, with various steps being carried out by software running on a computer processor, either locally on a user's computer, in a web-based format, or in an ASP format. As will be discussed in detail below, a sequence of eight activities (referred to herein as “arcs”) brings order and precision to the creative process of b-to-b messaging. Like the chambers of a nautilus shell, the progression of activities provided by the present invention is arranged in an expanding sequence of arcs, each of which represents a step in the message creation process. The present invention is sometimes referred to as the “Messaging Nautilus”.

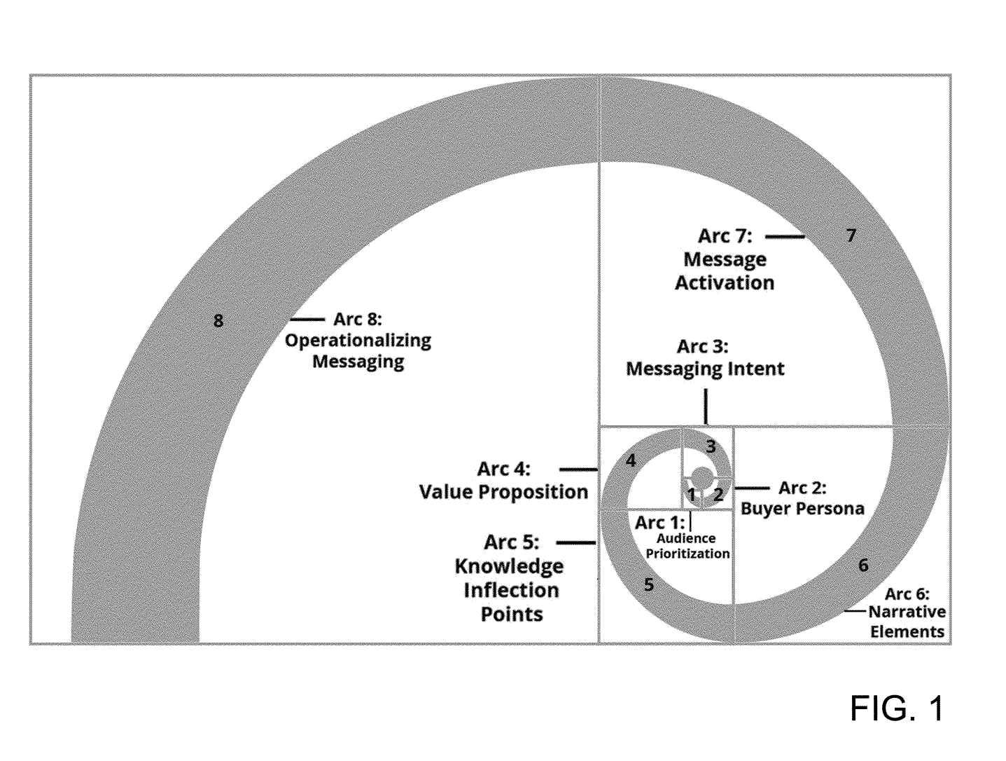

An example embodiment of the present invention is described in detail below in connection with FIG. 1 and arcs 1-8. The discussion of arcs 1-6 below each refers to one or more documents published by SiriusDecisions, Inc., the Assignee of the present invention, which are available on the SiriusDecisions' website, www.siriusdecisions.com. Each of these published documents are incorporated herein and made a part hereof by reference in their entirety and for all purposes.
Arc 1: Audience isolation/prioritization. This arc embodies an alignment exercise aimed at creating a shared understanding of target audiences with unique messaging requirements. Product, marketing and sales must agree on the target audience at the first stage of the content creation process in order to ensure that the messaging can later be activated by sales and marketing. Tools are also provided for inputting, classifying, and categorizing marketing content. Content is identified and associated with a primary audience (e.g., a buyer, customer, influencer, employee, sales manager, or the like).

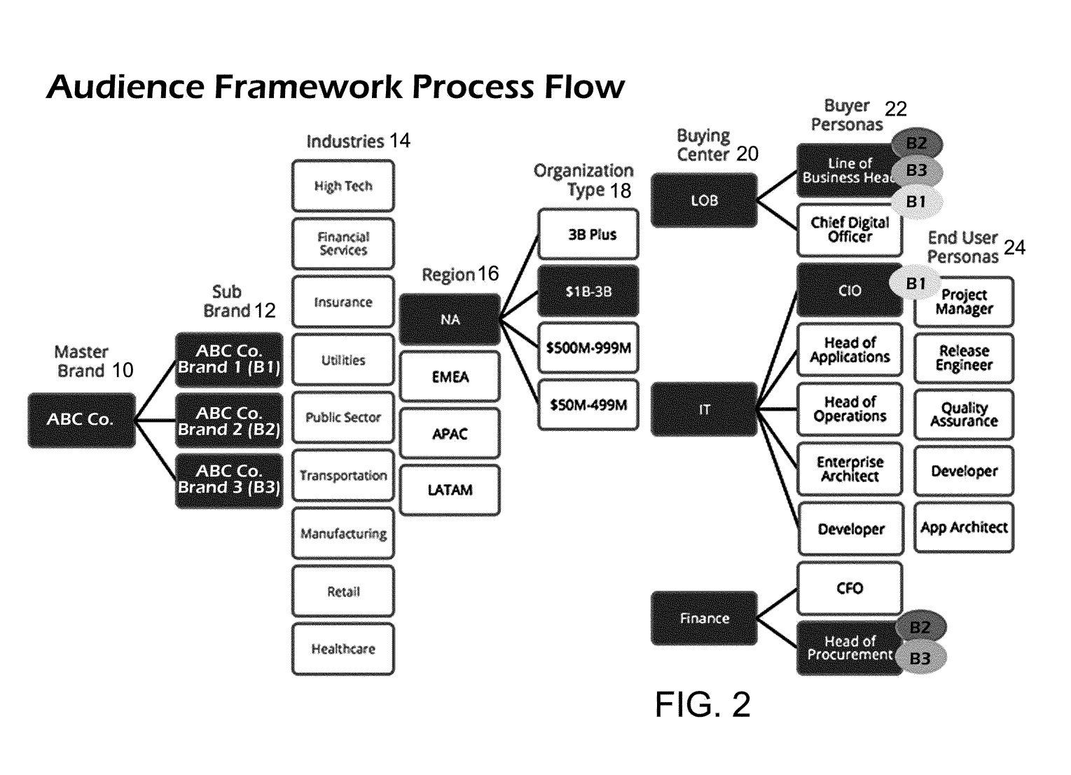

The tools may comprise software running on a computer processor and the information may be entered into a database via a user interface, as described below in connection with FIG. 2. The content itself may also be loaded into the database. The tools may enable automatic sorting and searching of the content based on the input information.

In this arc, an audience segment should not be defined as “everyone” or a set of accounts. In collaboration with product and sales, marketing must isolate the buyer personas that are involved in the purchasing decision for the offering and that will receive the messaging (see the SiriusDecisions' brief “Prioritizing Buyer Personas”). Market segmentation and sizing data is either input into the database or the user can leverage the data provided in the tool to select which market segments to focus the content and campaigns on. The market segmentation levels include industry, sub-vertical, enterprise size and geographic regions.

Once the market segments are chosen, there is an automated method for calculating buyer audiences (buying centers and buyer personas) to target with the messaging. A persona prioritization tool is provided for associating various personas with external and internal weighting factors, such that personas to be targeted can be scored and ranked (prioritized) automatically. For example, a scoring mechanism may be provided which may be based on a series of attributes that enables the user to select which persona targets are recommended by the tool as the best candidates.

Although messaging occasionally must be created for broader audience categories, it is recommended that most messaging components be constructed at the persona level. The output of this arc is a completed Audience Framework template (see the brief “The SiriusDecisions Content Model: Audience Framework”).

An example embodiment of an Audience Framework worksheet is shown in Table 1:

TABLE 1
Arc 1 Worksheet. Audience Framework

| | | Key Issues | Buyer Need |
|---|---|---|---|
| | Instructions | These are | What will |
| | | topics that | trigger each |
| | | drive | audience |
| | | urgency or | segment to |
| | | momentum | purchase |
| | | related to | the offering? |
| | | a buyer | The need |
| | | need—e.g. | to achieve |
| | | economic | a business |
| | | factors, | opportunity |
| | | industry | or goal |
| | | regulations, | or solve a |
| | | legal | business issue |
| | | changes, | through the |
| | | local trends. | application |
| | | | of an offering. |
| Industry | Define the key issues for the | | |
| | vertical segment related to | | |
| | industry-specific market | | |
| | trends, regulations, legal issues, | | |
| | market drivers or challenges. | | |
| | The buyer need should | | |
| | pinpoint the most significant | | |
| | problem or opportunity that | | |
| | professionals in that industry | | |
| | are collectively dealing with. | | |
| Region | Define the regions being | | |
| | targeted and how regional needs | | |
| | differ. Key issues revolve | | |
| | around trends specific to a | | |
| | geographic region (government | | |
| | regulations, cultural or | | |
| | economic factors). | | |
| Org Type | Large organizations' buyer | | |
| | needs are usually very different | | |
| | from the buyer needs | | |
| | of a startup; capture those | | |
| | differences here. | | |
| Buying | Buying centers are organizational | | |
| Center | entities (e.g. department, | | |
| | team, functional level) | | |
| | comprising a group of buyer | | |
| | personas who participate in | | |
| | decisions about what to | | |
| | purchase. Describe the key | | |
| | issues include business | | |
| | opportunities, organizational | | |
| | goals or business problems. | | |
| | Each buying center typically | | |
| | has its own primary buyer | | |
| | need. | | |
| Buyer | Explain the key business issues | | |
| Persona | related to the offering that | | |
| (s) | the specific persona cares | | |
| | about. Each buyer persona | | |
| | should have a differentiated | | |
| | primary buyer need. | | |

® 2014 SiriusDecisions All Rights Reserved 3 SiriusDecisions

[symbol]

The Audience Framework worksheet helps define the key issues and buyer needs for a particular industry, region, organization type, buying center, and buyer persona(s).

FIG. 2 illustrates an example embodiment of a buyer audience framework process flow and output. The buyer audience framework may be engineered at a master brand level 10 (for less complex portfolios) or a sub-brand level 12 (for larger, more complex portfolios). In either case, one or more offerings for the brand 10 or sub-brands 12 at issue are identified, along with the corresponding industry or industries 14 applicable to the brand or sub-brand (e.g., high tech, financial services, insurance, utilities, public sector, transportation, manufacturing, retail, healthcare, and the like). The corresponding region or regions 16 where markets exist for each brand or sub-brand are also identified (e.g., North America, EMEA (Europe, Middle East, Africa), Asia Pacific, Latin America, and the like). The organization type 18 is then selected for each brand or sub-brand. The organization type 18 may be defined by size, revenue or other factors. As an example only, FIG. 2 shows organization type defined by revenue (e.g., $3 billion or more, $1-3 billion, $500-999 million, $50-499 million). Other categorizations may be used. The buying centers 20 for each organization type are then identified (e.g., Line of Business, IT, Finance, and the like). The organization types 18 and buying centers 20 are selected based on the greatest opportunity for growth. Buyer personas 22 for each buying center are then identified. The buyer personas (e.g., job role dimension) that will be the most involved in the purchasing decision for each offering are chosen as targets for the campaign and content strategy. For example: for the line of business buying center, the buyer personas may include line of business head, chief digital officer, and the like: for the IT buying center, the buyer personas may include chief information officer, head of applications, head of operations, enterprise architect, developer, and the like; for the finance buying center, the buyer personas may include chief financial officer, head of procurement, and the like. Other buying centers and personas may be identified, depending on the brand and industry. The buyer needs are then isolated and the offering portfolio for the enterprise is mapped to bring visibility to where business units share a persona or where they are distinct.

In the example shown in FIG. 2, the enterprise is mapped as being in the North American region and a $1-3 billion dollar company with targeted personas from line of business, IT and finance buying centers. In the example shown, Sub-Brands 1, 2, and 3 (B1, B2, and B3) are shown as sharing the targeted persona “line of business head”, with an additional targeted persona for the offering(s) for sub-brand 1 (B1) identified as the chief information officer of the IT buying center. The head of procurement of the finance buying center is also identified as a target persona for the offering(s) for sub-brands 2 and 3 (B2 and B3).

End user personas 24 may also be identified/selected (e.g., project manager, release engineer, quality assurance, developer, application architect, and the like). End-user personas are the actual users of the product or consumers of the services. Sometimes they participate or control the decision to purchase but many times, the offering is purchased by the buyer persona on behalf of the end-users. For example, the CFO and financial team may purchase an expense reporting system for the organization. In such a case, every associate in the organization is an end-user. It is thus important to define end-users as part of the audience framework to clearly delineate where buying control resides in the buying audience as well as to identify tangential or associated end-users who may influence the decision to purchase.
Arc 2l Buyer Persona context. Ultimately, organizations must create messaging that speaks precisely to buyers' primary needs, using their tone and vernacular, covering business issues and topics they care about. In this stage, buyer personas are defined and key attributes are identified to enable informed content preferences and messaging resonance. Personas may include head of marketing, head of sales, head of finance, marketing operations leader, head of IT, business owner, and the like. Robust and precise definition of the personas is critical for creating this audience-centric messaging. Portfolio marketers must collect sufficient persona insights to complete the SiriusDecisions Persona Template (see the Core Strategy Report “B-to-B Personas”) and internalize persona knowledge. The output of this stage is a description of each persona's primary buyer need and a list of the keywords and phrases in each persona's lexicon.

An example embodiment of Persona Definition worksheet is shown in Table 2:

TABLE 2
Arc 2 Worksheet. Persona Definition

| | | Persona |
|---|---|---|
| Attributes | Instructions | Insights |
| Job Role | Individuals should be grouped by their | |
| | day-to-day responsibilties, accountabilities and | |
| | how their performance is measured (e.g. | |
| | management by objectives). What they do? | |
| | Describe a day in the site. | |
| Common | Compile the titles commonly | |
| Titles | associated with the job role. | |
| Buying | List the entity that holds the budget for a | |
| Center | purchase, typically a business unit, | |
| | department or team. | |
| Position | The persona's position in the organization | |
| On Org | is an important indicator of decision making | |
| Chart | impact and influence. Do they report | |
| | into the buying center or not? | |
| Initiatives | Find out what programs and projects the | |
| | person is tasked with, and capture their | |
| | feelings and aspirations about these | |
| | initiatives. What are their motivations? How do | |
| | they earn credibility and get promoted? | |
| Challenges | Identify the persona's business issues, | |
| | problems and pain points, including factors | |
| | that could impede the persona's attainment | |
| | of objectives. Capture the persona's | |
| | feelings about these challenges | |
| | (e.g. fears, uncertainties, doubts). | |
| Buyer Role | List the buyer role characterized by decision | |
| Type | making criteria and power level. The five | |
| | common buyer roles are champion, influencer, | |
| | decision maker(or economic buyer), | |
| | user and raidier (a professional | |
| | purchaser or negotiator). | |
| Buyer Need | A persona may have multiple needs; isolate | |
| | the primary buyer need that is most likely | |
| | to attract the persona to the offering | |
| Lexicon | Note the specific vernacular. What are the | |
| | keywords and phrases they organically use | |
| | to discuss the buyer need or business issue? | |
| Content | List the persona's content preferences (e.g. | |
| Preferences | type of information, format). For example, | |
| | a persona may prefer short-term content | |
| | assets (e.g. blog, infographic, demo, video) | |
| | over long-form assets (e.g. white paper, case | |
| | study, presentation, analyst report). | |
| Tactic | List the different ways of interacting with the | |
| Preferences | selling organization (e.g. in-person | |
| | meetings, phone calls, emails, video | |
| | conferencing, conducting research via Web, | |
| | mobile and social media). | |
| Watering Holes | These are physical or virtual places where the | |
| | persona goes to network or exchange | |
| | information with peers (e.g. Linkedin, | |
| | online communities, forums, publications, | |
| | events). | |

® 2014 SiriusDecisions All Rights Reserved 4 SiriusDecisions [symbol] ₄

The Persona Definition worksheet assists in defining attributes of the various personas (e.g., job role, title, position in organization, job initiatives, business challenges, type of buyer role, lexicon, content preferences, tactic preferences, and watering holes for information gathering). An automated tool may be provided that leverages the SiriusDecisions Buyer Persona Framework which is a definitional model representing a series of required attributes to categorize and define a b-to-b buyer persona. The user can either input their own data into the tool or leverage pre-existing data that the tool provides based on prior research results which may be stored in the database. The persona definitions may be loaded into the database.
Arc 3: Messaging Intent. The objective of this step is to align messaging strategy to the market context (e.g. demand type for the offering) into which the offer is being extended. While the narrative elements of messaging components will be adjusted later in the process based on demand type (e.g. new concept, new paradigm, established market), portfolio marketers may use the SiriusDecisions Demand Spectrum Framework in this arc to define and document messaging intent (e.g. evangelize, provoke, compete). The output of this arc is a messaging strategy statement that describes what the messaging is intended to do or what observable outcome it should achieve (see the brief “So, What's your (Demand) Type?”).

An example embodiment of Messaging Intent worksheet is shown in Table 3:

TABLE 3
Arc 3 Worksheet. Messaging Intent

| Demand Spectrum | Description | Intent |
|---|---|---|
| New Concept | For offerings that address a problem | Evangelize |
| | or opportunity potential buyers | |
| | aren't even aware of. Requires intensive | |
| | issue opportunity creation and | |
| | education on the part of the seller and | |
| | budget line item creation on the | |
| | part of the buyer. | |
| New Paradigm | For offerings that solve a known | Provoke |
| | problem in a new or better way | |
| | Requires the seller to make case | |
| | for new solution type and mitigate | |
| | perceived risk associated with | |
| | change. Requires business process | |
| | change on the part of the buyer and | |
| | sometimes new budget line item. | |
| Established Market | For offerings that are bought by virtually | Compete |
| | every buyer in a target market. | |
| | Requires the seller to make case for a | |
| | superior solution through features, | |
| | cost, or services. | |

Demand Type: Based on the market situation for the offering, what is the SiriusDecisions demand type?.
Strategy Statement: State the objective of the messaging intent and business outcomes desired.

The Messaging Intent worksheet is used to define the demand type based on the market situation for the offering and to create a strategy statement based on the objective of the messaging intent and business outcome desired. The new concept demand type is for offerings that address a problem or opportunity potential buyers aren't even aware of, and requires intensive issue/opportunity creation and education on the part of the seller, along with a budget line item creation on the part of the buyer. The intent of the new concept demand type is defined as “Evangelize”.

The new paradigm demand type is for offerings that solve a known problem in a new or better way than standard solutions. This demand type requires the seller to make a case for the new solution and mitigate perceived risk associated with a change to the new solution. This demand type requires business process change on the part of the buyer and sometimes a new budget line item. The intent of the new paradigm demand type is defined as “provoke”.

The established market demand type is for offerings that are bought by virtually every buyer in a target market, and requires the seller to make a case for a superior solution through the features, costs, or services provided. The intent of the established market demand type is defined as “compete”. The demand type and strategy statement for the offering may be loaded into the database.
Arc 4: Value proposition. A value proposition is the most basic articulation of the offering's value to a particular audience. However, creating value propositions has become a lost art in b-to-b marketing. The SiriusDecisions Value Proposition Framework is used during this step to construct a value proposition with thoughtful, fact-based claims centering on the persona's primary buyer need, rather than a simple product descriptor or paraphrasing the offering's functionality. The value of an offering is connected to the primary buyer need of the audience, and centers on the audience, not the offering. A single offering most likely will require a value proposition for each persona it is sold to—and possibly multiple value propositions for a single persona if several buyer needs are present. Each value proposition should include five components: audience, need, assertion, outcome and distinction (see the briefs “Crafting a Product or Solution Value Proposition” and “B-to-B Messaging Echelons”). An example embodiment of Value Proposition worksheet is shown in Table 4:

TABLE 4
Arc 4 Worksheet: Value Proposition

| | Instructions | Explanation Notes | Building Block |
|---|---|---|---|
| | | Based on the | Summarize |
| | | persona definition, | and shorten |
| | | tilt in long | the notes into |
| | | descriptions | phrases or |
| | | that explain | words that |
| | | each one of the | will become |
| | | value proposition | the value |
| | | components for | proposition |
| | | the offering. | sentence. |
| Audience | Identify a unique buyer | | |
| | persona involved in | | |
| | the purchase process | | |
| | for the offering. | | |
| Need | Define the need for | | |
| | the buyer persona | | |
| | that's most critical to | | |
| | their goals, initiatives | | |
| | and challenges | | |
| | relative to the offering. | | |
| Assertion | Explain “how” the | | |
| | offering addresses | | |
| | the need. | | |
| Outcome | Describe the business or | | |
| | personal value that | | |
| | will be achieved for | | |
| | that buyer persona if | | |
| | they purchase and | | |
| | engage with the offering. | | |
| Distinction | Isolate the element that | | |
| | makes the offering | | |
| | unique to other | | |
| | alaternatives available | | |
| | to the buyer. | | |

Value Proposition: Using the building blocks from the worksheet above, construct the value statement for the offering.
® 2014 SiriusDecisions All Rights Reserved ε SiriusDecisions

[symbol]

Using this worksheet, a description is provided that, based on the persona definition, explains each of the value proposition components for the offering. These definitions are then shortened into phrases or words that will become the value proposition sentence. This is done for each of the value proposition components: audience, need, assertion, outcome, and distinction. For the audience component, a unique buyer persona involved in the purchase process for the offering is defined. For the need component, a need is defined for that buyer persona that is most critical to their goals, initiatives, and challenges relating to the offering. For the assertion component, an explanation is provided as to how the offering addresses the need. For the outcome component, a description is provided for the business or personal value that will be achieved for that buyer persona if they purchase and engage with the offering. For the distinction component, the element is isolated that makes the offering unique to other alternatives available to the buyer. Once the definitions for each value proposition are created and shortened, the value statement/proposition for the offering can be created using these building blocks. The definitions may be loaded into the database and the shortening of the definitions into keywords or phrases, and the creation of the value proposition from these keywords and/or phrases, can be an automated process carried out by software running on the processor.
Arc 5: Inflection points. During this step, portfolio marketers ensure that messaging content takes into account buyers' purchasing behavior (e.g. information needs, content preferences) at each stage. The characteristics of the buying cycle depend on the industry, demand type and the offering itself (e.g. complex, expensive solution vs. transactional product). The SiriusDecisions Buying Cycle Framework (see the brief “Inside a Customer Buying cycle”) and Customer Lifecycle Framework may be leveraged to help define and validate the stages of the buying process and customer lifecycle. Designing messaging to match inflection points requires more than simply assigning an asset type to each stage (e.g. white paper at early stages, case study at late stages). To engineer the messaging foundation, portfolio marketers must understand each persona's understandings and knowledge requirements at each stage as well as the information components and psychological reassurance required not just to satisfy buyers' current needs, but also to advance them to the next stage. The determination of the inflection points depends in part on the demand type and corresponding messaging intent, and may be different for the New Concept, New Paradigm, and Established Market demand types.

An example embodiment of a Knowledge Inflection Points worksheet for the New Concept demand type is shown in Table 5a:

TABLE 5a
Arc 5 Worksheet. Knowlegde Inflection Points

| | | Knowledge Requirements |
|---|---|---|
| | New Concept | Map out the questions |
| | | that buyers have at each |
| | | stage in the journey. |
| | | Put yourself in the |
| | | shoes of the buyer, and |
| | | identify the key issues |
| | | and questions they are |
| | | struggling with at |
| | | each stage. |
| Education | Loosening of the Status Quo | |
| | Why is this business issue important | |
| | to address now, and what are its | |
| | market, technology, and economic | |
| | drivers? What do industry experts | |
| | and thought leaders think about the | |
| | relevance of the issue and its | |
| | impact on the business | |
| | environment? | |
| | Committing to Change | |
| | Why should we have this on our | |
| | radar? Are peer companies paying | |
| | attention to this issue? Does the | |
| | new concept represent a validated | |
| | shift in the industry vs. | |
| | an unsubstantiated trend? | |
| Solution | Exploring Possible Solutions | |
| | What is the solution? How does it | |
| | work and how does it address this | |
| | business issue? | |
| | How will this offering | |
| | impact the current environment | |
| | and processes? What are the risks | |
| | and why are they worth taking? | |
| | Committing to a Solution | |
| | What data or proof justify the | |
| | investment in the solution | |
| | of this problem? | |
| | What are the risks of the status | |
| | quo, what are the risks | |
| | of the new solution and how to | |
| | they balance out in favor of | |
| | investment? | |
| Selection | Justifying the Decision | |
| | What is the priority level of the | |
| | offering vs. other business cases | |
| | that are vying for funds? Is this | |
| | the right investment for the | |
| | company at the right time? Is | |
| | there a competitive | |
| | advantage in early | |
| | adoption? Will the expected value | |
| | outweigh the disruption involved? | |
| | Making the Selection | |
| | Is adopting the new concept the | |
| | best decision for | |
| | the company, and is | |
| | the vendor the right partner for the | |
| | long term? The persona may also | |
| | be looking for a way to influence | |
| | other personas that feel less | |
| | positive about the new concept. | |

® 2014 SiriusDecisions All Rights Reserved 3 SiriusDecisions

[symbol]

In this worksheet, knowledge requirements for buyer education, solution, and selection stages are mapped out so that key issues and questions can be identified. The parameters to be considered at each stage are defined in Table 5a, including: “loosening of the status quo” and “committing to change” for the education stage; “exploring possible solutions” and “committing to a solution” for the solution stage; and “justifying the decision” and “making the selection” for the selection stage.

An example embodiment of a Knowledge Inflection Points worksheet for the New Paradigm demand type is shown in Table 5b:

TABLE 5b
Arc 5 Worksheet. Knowlegde Inflection Points

| | | Knowledge Requirements |
|---|---|---|
| | New Paradigm | Map out the questions |
| | | that buyers have at each |
| | | stage in the journey. |
| | | Put yourself in the |
| | | shoes of the buyer, |
| | | and identify |
| | | the key issues |
| | | and questions they |
| | | are struggling with at |
| | | each stage. |
| Edu- | Loosening of the Status Quo | |
| cation | How does the alternative solution | |
| | satisfy unmet needs or how is it | |
| | better than the current solution? | |
| | How will changing the way we solve | |
| | this problem impact our process? | |
| | What are the risks? | |
| | Committing to Change | |
| | What are the negative consequences | |
| | of keeping the current solution? | |
| | How is it an impediment to remaining | |
| | competitive? Is this a true | |
| | industry shift or just a trend? | |
| | How can a potential partner help me | |
| | mitigate disruption, as we | |
| | make the proposed change? | |
| Solu- | Exploring Possible Solutions | |
| tion | What innovations in technology | |
| | or methodology enable new or | |
| | additional value? Which alternatives | |
| | are stable and sustainable? | |
| | What changes in skill sets, processes | |
| | and technology must the buyer | |
| | organization make before realizing | |
| | each solution's full benefits and | |
| | value? What are the paths for | |
| | migration and associated risks? | |
| | Committing to a Solution | |
| | Does the seller have the technical | |
| | or subject-matter prowess and | |
| | resources to ensure sustainable | |
| | innovation? Does it have experience | |
| | delivering value in a similar | |
| | customer environment? How does the | |
| | seller respond to the buyer's specific | |
| | business needs and challenges? | |
| Selec- | Justifying the Decision | |
| tion | Why should the company switch to | |
| | the new alternative now? How will | |
| | this change help to provide a | |
| | competitive advantage? | |
| | Making the Selection | |
| | Is this the right decision for the | |
| | company? Is this the right partner? | |
| | How will we mitigate business | |
| | disruption during this | |
| | period of change? | |
| | How will the seller | |
| | support this plan of action? | |

® 2014 SiriusDecisions All Rights Reserved 11 SiriusDecisions

[symbol]

For the New Paradigm demand type, the process is similar to that described above for the New Concept demand type, except that the parameters for the three stages are defined differently, as can be seen via a comparison of the content of Tables 5a and 5b.

An example embodiment of a Knowledge Inflection Points worksheet for the Established Market demand type is shown in Table 5c:

TABLE 5c
Arc 5 Worksheet. Knowlegde Inflection Points

| | | Knowledge Requirements |
|---|---|---|
| | Established Market | Map out the questions |
| | | that buyers have at each |
| | | stage in the journey. |
| | | Put yourself in the |
| | | shoes of the buyer, |
| | | and identify the key |
| | | issues and questions they |
| | | are struggling with at |
| | | each stage. |
| Education | Loosening of the Status Quo | |
| | Does the seller really understand | |
| | my business needs? Are they | |
| | a leader or a laggard in the industry? | |
| | What additional information | |
| | or value can they provide me | |
| | on the industry as a whole? | |
| | Committing to Change | |
| | Why should I change service | |
| | providers or displace the | |
| | incumbent product? | |
| | Why shouldn't I? | |
| Solution | Exploring Possible Solutions | |
| | What could an alternative solution | |
| | provide that is better than the | |
| | one I currently have in place? | |
| | Committing to a Solution | |
| | What features, functionality, | |
| | and benefits are unique to the | |
| | solution and how do these | |
| | qualities provide value? | |
| Selection | Justifying the Decision | |
| | Why should we keep (or increase) | |
| | the budget in place for this | |
| | offering, or why should we buy this | |
| | offering when the competetion | |
| | has a lower-priced option? Will | |
| | this investment help grow the | |
| | company, provide competitive | |
| | advantage, or save time or | |
| | money? | |
| | Making the Selection | |
| | How can I validate the decision to | |
| | renew or purchase? How can I | |
| | influence my peers to see my | |
| | perspective on this? What are the | |
| | risks of switching vendors and | |
| | how will the seller help mitigate | |
| | this disruption? | |

® 2014 SiriusDecisions All Rights Reserved 14 SiriusDecisions

[symbol]

For the Established Market demand type, the process is similar to that described above for the New Concept and New Paradigm demand types, except that the parameters for the three stages are defined differently, as can be seen via a comparison of the content of Tables 5a, 5b, and 5c.

The inflection points for each demand type can be entered into the database.
Arc 6: Narrative elements. During this step, core messaging components are created to support advancement from one stage of the buyer's journey or customer lifecycle to the next (see the brief “The SiriusDecisions Product Messaging Map Framework”). These raw components (e.g. bullets, phrases, words) will be assembled into assets during the downstream content creation process, which may be carried out by software running on the processor. The messaging components should be designed to work either separately or together, depending on the asset format, and tell a logical story to guide buyers through their decision making process, regardless of the content delivery mechanism. Narrative elements should take into account the knowledge requirements at each stage of the buyer's journey (see the briefs “Messaging by Demand Type: Established Market,” “Messaging by Demand Type: New Paradigm” and “Messaging by Demand Type: New Concept”). The messaging components will be based in part on demand type.

An example embodiment of a Narrative Elements worksheet for the New Concept demand type is shown in Table 6a:

TABLE 6a
Arc 6 Worksheet. Narrative Elements

| | | Messaging | Content |
|---|---|---|---|
| | | Components | Offers |
| | New Concept | How will you | Consider |
| | | meet this buyer's | potential |
| | | knowledge | content |
| | | requirements? | offers for |
| | | In bullet | delivering |
| | | format, detail the | each |
| | | information that | component |
| | | needs to be | based |
| | | delivered at | on the tactic |
| | | each stage. | and asset |
| | | | preferences of |
| | | | the persona |
| Edu- | Loosening of the Status Quo | | |
| cation | Innovation or insight that | | |
| | that captures the | | |
| | persona's attention and | | |
| | triggers realization of | | |
| | business problem or opportunity. | | |
| | Committing to Change | | |
| | “Issue creator” statements | | |
| | that illuminate pain | | |
| | or opportunity and create | | |
| | a sense of urgency | | |
| | to seek take action | | |
| Solu- | Exploring Possible Solutions | | |
| tion | Bullets that enable persona | | |
| | to understand what | | |
| | the new offering is and how it | | |
| | remedies or exploit the situation | | |
| | Committing to a Solution | | |
| | Bullets illustrating | | |
| | capabilities and value in | | |
| | context of buyer | | |
| | persona challenges. | | |
| Selec- | Justifying the Decision | | |
| tion | Benefits and value | | |
| | delivered, specific points of | | |
| | impact to business | | |
| | drivers—must drive budget | | |
| | justification. | | |
| | Making the Selection | | |
| | Concept validation | | |
| | from influencers, | | |
| | testimonials or case | | |
| | studies from beta | | |
| | customers, first wins. | | |

® 2014 SiriusDecisions All Rights Reserved 9 SiriusDecisions

[symbol]

In this worksheet, messaging components and content offers are determined for each buyer stage of education, solution, and selection. The parameters for each stage are the same as that defined above with regard to Arc 5, but the considerations for these parameters are different at this stage, as is apparent from a comparison of Tables 5a and 6a.

An example embodiment of a Narrative Elements worksheet for the New Paradigm demand type is shown in Table 6b:

TABLE 6b
Arc 6 Worksheet. Narrative Elements

| | | Messaging | Content |
|---|---|---|---|
| | | Components | Offers |
| | New Paradigm | How will you | Consider |
| | | meet this | potential |
| | | buyer's | content |
| | | requirements? | offers for |
| | | In bullet format, | delivering |
| | | detail the information | each |
| | | that needs to | component |
| | | be delivered at | based on the |
| | | each stage. | tactic and asset |
| | | | preferences |
| | | | of the persona |
| Edu- | Loosening of the Status Quo | | |
| cation | Topic that connects the | | |
| | persona with the known | | |
| | problem or opportunity | | |
| | and that the current | | |
| | solution type is not optimal. | | |
| | Committing to Change | | |
| | Provocative statements | | |
| | that illuminate current | | |
| | areas of dissatisfaction | | |
| | and recast possible | | |
| | solutions to known problem. | | |
| Solu- | Exploring Possible Solutions | | |
| tion | Bullets that connect | | |
| | offering as better solution to | | |
| | old paradigm problems. | | |
| | Committing to a Solution | | |
| | Bullets mitigating risk or | | |
| | concerns of the buyer | | |
| | persona. | | |
| Selec- | Justifying the Decision | | |
| tion | Bullets supporting rationale | | |
| | to switch solution | | |
| | type—benefits and value | | |
| | delivered by moving to | | |
| | new alternative. | | |
| | Making the Selection | | |
| | Testimonials or case | | |
| | studies from customers | | |
| | illustrating ease of | | |
| | migration and benefits of | | |
| | change. | | |

® 2014 SiriusDecisions All Rights Reserved 12 SiriusDecisions

[symbol]

For the New Paradigm demand type, the process is similar to that described above for the New Concept demand type, except that the parameters for the three stages are defined differently, as can be seen via a comparison of the content of Tables 6a and 6b.

An example embodiment of a Narrative Elements worksheet for the Established Market demand type is shown in Table 6c:

TABLE 6c
Arc 6 Worksheet. Narrative Elements

| | | Messaging | Content |
|---|---|---|---|
| | | Components | Offers |
| | Established Market | How will you | Consider |
| | | meet this buyer's | potential |
| | | knowledge | content |
| | | requirements? | offers for |
| | | In bullet format, | delivering |
| | | detail the | each |
| | | information | component |
| | | that needs to | based on |
| | | be delivered at | the tactic |
| | | each stage. | and asset |
| | | | preferences |
| | | | of the |
| | | | persona. |
| Edu- | Loosening of the Status Quo | | |
| cation | Topic or theme that | | |
| | connects persona as well as | | |
| | elucidates key differentiator | | |
| | or unique value. | | |
| | Committing to Change | | |
| | Promotional trigger or | | |
| | incentive that will persuade | | |
| | persona to take action; this | | |
| | will either be an attack or | | |
| | defend messaging strategy. | | |
| Solu- | Exploring Possible Solutions | | |
| tion | Bullets that describe business | | |
| | value impact that the | | |
| | persona cares about, | | |
| | how does these benefits | | |
| | compare to competitive offerings? | | |
| | Committing to a Solution | | |
| | Bullets that compare | | |
| | conpetitive offerings in context | | |
| | of persona's distinct buyer need. | | |
| Selec- | Justifying the Decision | | |
| tion | Facts, figures and proof | | |
| | points enabling competitive | | |
| | comparisons and decision | | |
| | to retain or buy. | | |
| | Making the Selection | | |
| | Stories or testimonials of | | |
| | competitive wins and win | | |
| | backs showing unique | | |
| | differentiation—real or | | |
| | perceived. | | |

® 2014 SiriusDecisions All Rights Reserved 15 SiriusDecisions

[symbol]

For the Established Market demand type, the process is similar to that described above for the New Concept and New Paradigm demand type, except that the parameters for the three stages are defined differently, as can be seen via a comparison of the content of Tables 6a, 6b, and 6c.

The messaging components for each stage of each demand type are entered into the database. Particular content identified for each stage of each demand type, which was entered and is present in the database as a result of the Arc 1 process, may be linked either to the messaging component, or the stage for the corresponding demand type.
Arc 7: Activation mapping. When creating messaging components, portfolio marketers must understand and consider messaging formats (asset types) and avenues of delivery (channels) in order to use the right tone, style and structure of the messaging components. Messaging must also take into account broader marketing plans and campaign strategy. In this arc, portfolio marketers align with campaign planning function, content operations and sales enablement to understand the assets and channels that will be used to distribute the messaging narrative, as well as how campaigns will shape the message. Using the campaign plan or sales enablement plan, the groups then jointly construct a content blueprint for the final assembled messaging components. This step minimizes rework and wasted effort downstream in the activation phase of the content process or campaign execution. The production source is determined for each asset in this arc. While portfolio marketers will originate some assets (e.g. by filling in a battlecard or Web page template), an internal or external creative team is typically responsible for others (e.g. infographics, videos). The messaging templates may be entered into the database for subsequent use.

An example embodiment of an Activation Mapping worksheet is shown in Table 7:

TABLE 7

| | Asset Types | | |
|---|---|---|---|
| | List the content assets that | Delivery Channels | |
| | need to be created based on | List the mechanism that | Copy Block |
| | the tactic and asset | will deliver that asset (e.g. | Insert the final messaging for that asset, or insert the |
| ARC 7: | preferences of the persona | Web site, channel partner | hyperlink to the asset template or content brief you |
| Activation | and the campaign plan. | portal, Linkedin sponsored | have filled out in order to have the content asset |
| Mapping | (Examples are listed below.) | ad.) | created. |
| | Tagline or One-Line | | |
| | Descriptor | | |
| | Media Announcement | | |
| | Elevator Pitch | | |
| | Search Keywords | | |
| | Offering Description | | |
| | Point of View (Business | | |
| | Issue Perspectives) | | |
| | Prospecting Email | | |
| | Quotes | | |
| | Infographics (Data Points) | | |
| | Presentation Session | | |
| | Abstract | | |
| | Tweets | | |
| | Blog | | |
| | Case Studies | | |

For each type of asset or content (e.g., tagline or one line descriptor, media announcement, elevator pitch, search keywords, offering description, point of view, prospecting email, quotes, infographic, presentation session abstract, tweets, blog, case studies, and the like), possible delivery channels or delivery mechanisms are identified (e.g., website, channel partner portal, web-based ad such as LinkedIn sponsored ad, and the like). The final messaging for the asset, or a hyperlink for the asset, is then provided for each asset or content type and the corresponding delivery channel/mechanism. The associations of asset or content type with the corresponding delivery channel/mechanism can be stored in the database and linked to the corresponding asset or content identified, for later use in the activation process.
Arc 8: Operationalize. In this arc, portfolio marketers populate messaging templates, using the messaging components to create the message content. The populated messaging templates are then passed to communications or integrated marketing for activation. The messaging templates are structured to enable audience-centric messaging assembled from the messaging components produced earlier. In this arc, careful attention is paid to content localization: Portfolio marketers must understand regional requirements before creative production and assembly, and note localization needs in messaging template instructions. Finally, the Messaging Nautilus template is completed as the final output of the messaging sequence.

Table 8 below illustrates example outputs of each audience-centric messaging process in accordance with an example embodiment of the present invention:

TABLE 8
Arc 1: Audience Isolation

| | | | | | | | |
|---|---|---|---|---|---|---|---|
| Master | Offering | Industry | Region | Sub- | Organization | Buying | Persona |
| Brand | | | | Vertical | Type | Center | |

Arc 2: Persona Context

| | | | | | | | | |
|---|---|---|---|---|---|---|---|---|
| Job Role | Initiatives | Challenges | Primary | Lexicon | Content | Buying | Decision | Watering |
| | | | Buyer Need | | Preferences | Process | Drivers | Holes |

Arc 3: Intent

| | | |
|---|---|---|
| New Paradigm: Provoke | Established Market: Compete | New Concept: Evangelize |

Arc 4: Value Proposition

| | | | | |
|---|---|---|---|---|
| Audience | Need | Assertion | Outcome | Distinction |

Arc 5: Inflection Points

| | | |
|---|---|---|
| Education Knowledge | Solution Knowledge | Selection Knowledge |
| Requirements | Requirements | Requirements |

Arc 6: Narrative Elements

| | | | | | |
|---|---|---|---|---|---|
| Inform | Trigger | Benefit | Differentiate | Business Case | Confirm |

Arc 7: Activation Mapping

| | | | | | |
|---|---|---|---|---|---|
| Program | Delivery | Format | Interaction Type | Asset Type | Source |
| | Channel | | | | |

These outputs may be automatically provided to communications and/or integrated marketing for activation and distribution. It is noted that Arc number 8 is not included in the above Table as Arc number 8 relates to operationalizing of the previous 7 Arcs.

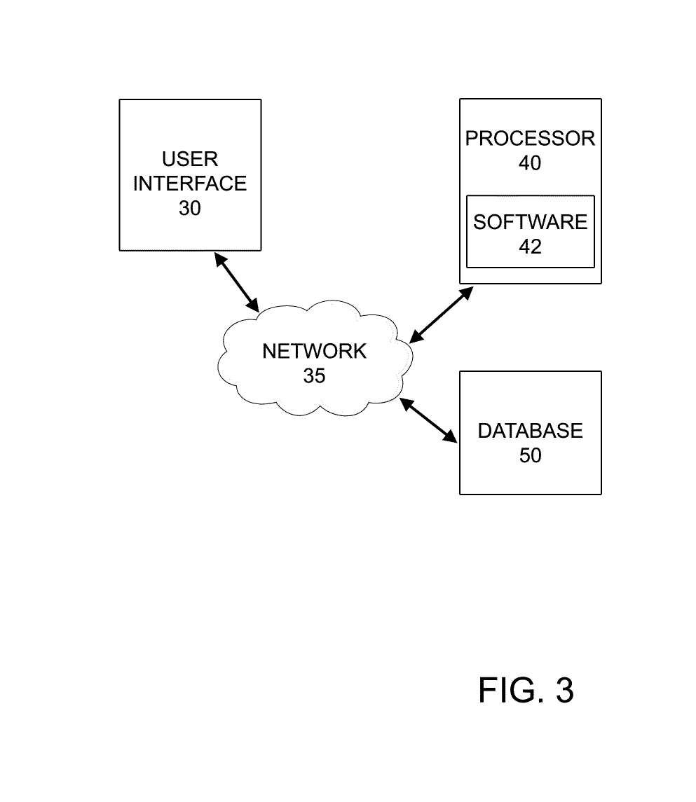

FIG. 3 shows an example embodiment of a system for implementing the present invention, including the various tools mentioned above. The system includes a user interface 30 via which any data for any of the arcs discussed above can be entered. A processor 40 is provided for running one or more software programs 42 for carrying out automated functions of the arcs on the entered data. A database 50 is associated with the processor 40 and the user interface 30 for storing entered data and any results of the software processing, for each of the arcs. FIG. 3 shows the user interface 30, processor 40, and database 50 connected to one another via a network 35, such as the Internet, an intranet, a wide area network or a local area network. Those skilled in the art will appreciate that user interface 30, processor 40, and database 50 may be implemented on the same device, or may be located separately at the same or at one or more different locations.

Worksheets 1-7 set forth above may be implemented as web-based forms presented on the user interface 30. Information entered on the web-based forms may be stored in the database 50 for use by the processor 40 and software applications 42 to provide the outputs described above.

The user interface 30 may comprise a computing device with a keyboard and screen, such as a personal computer, a portable computer, a tablet computer, a smartphone or any other Internet enabled device. The processor 40 may be implemented on the same or different computing device. For example, the processor 40 may be located at a central server accessible by a number of users each having a dedicated user interface 30. The database 50 may be implemented as a separate database, as several databases each for storing different types of data and content identified herein, or may be integrated into the user interface device 30 or the processor device 40 as memory associated therewith.

While b-to-b organizations are at varying levels of maturity for gathering persona insights and intelligence, even organizations with advanced persona knowledge sometimes revert to product-centric messaging because they have not changed their core messaging frameworks. To truly benefit from persona insights and enable audience-centricity, marketers must overhaul their messaging process. The eight arcs of the Messaging Nautilus provided by the present invention provide a step-by-step methodology for delivering the truly relevant messaging that buyers require, while making the content creation process more efficient from start to finish.

It should now be appreciated that the present invention provides advantageous systems and methods for creating audience-centric messaging templates and message content for use in business-to-business sales and marketing.

Although the invention has been described in connection with various illustrated embodiments, numerous modifications and adaptations may be made thereto without departing from the spirit and scope of the invention as set forth in the claims.

What is claimed is:

1. An automated method for creating marketing messaging templates and messaging content, comprising:
providing a sequence of automated messaging processes, the messaging processes comprising:
an audience isolation sequence for defining a target audience for the message and categorizing associated content, the target audience being defined by personas entered into a database in a prioritized manner and associated with content stored in the database;
a persona context sequence for identifying buyer need and buyer-specific lexicon for each of the personas, and storing persona attributes in the database for each of the personas;
an intent sequence for defining and documenting message intent of the message for each of three demand types comprising new concept, new paradigm, and established markets, and assigning a demand type and strategy statement to each offering, the demand types and strategy statements being entered into the database;
a value proposition sequence for creating definitions for one or more value propositions for an offering subject to the message and the corresponding demand type, and storing the definitions in the database;
an inflection points sequence for defining buyer information needs and content preferences for the message, and storing the inflection points in the database;
a narrative elements sequence for creating core messaging components for the message for each demand type and storing the messaging components in the database;
an activation mapping sequence for constructing a content blueprint for assembling one or more of the messaging components to create messaging templates, which are stored in the database; and
an operationalize sequence for automatically populating the messaging templates based on the messaging components; and
activating the populated messaging templates for electronic delivery to a buyer.
